(19) United States
(12) Patent Application Publication
(10) Pub. No.: US 2005/0165636 A1
(43) Pub. Date: Jul. 28, 2005

(54) Method for developing leaders in cyber security

(76) Inventor: Kamal T. Jabbour, Pompey, NY (US)

Correspondence Address: AIR FORCE RESEARCH LABORATORY IFOJ, 26 ELECTRONIC PARKWAY, ROME, NY, 13441-4514, US

(21) Appl. No.: 10/922,007

(22) Filed: Aug. 19, 2004

Related U.S. Application Data
(60) Provisional application No. 60/539,795, filed on Jan. 28, 2004.

(51) Int. Cl. G06F 17/60

(52) U.S. Cl. 705/11

(57) ABSTRACT

Method for developing leaders in cyber security. Cyber security candidates are selected according to a series of qualifying process steps. Cyber security leader-selectees are then developed into cyber-security leaders through a repetitive, multiple week program of problem solving skill development with emphasis on-time performance; communication skill development through impeccable technical writing and compelling presentations; and by mentoring from experienced cyber security professionals.

### PRIORITY CLAIM UNDER 35 U.S.C. §119(e)

This patent application claims the priority benefit of the filing date of a provisional application Ser. No. 60/539,795, filed in the United States Patent and Trademark Office on Jan. 28, 2004.

### STATEMENT OF GOVERNMENT INTEREST

The invention described herein may be manufactured and used by or for the Government of the United States for governmental purposes without the payment of any royalty thereon.

### BACKGROUND OF THE INVENTION

In his introduction of The National Strategy to Secure Cyberspace, President George W. Bush wrote that “securing cyberspace is an extraordinarily difficult strategic challenge that requires coordinated and focused effort from our entire society” and that “the cornerstone of America's cyberspace security strategy is a public-private partnership.”

Far from creating another computer security training program such as found in the prior art, what is needed is a method to develop leadership skills through problem solving and technical excellence. It would serve actual cyber security needs much better if students were to be faced with a real-world problem, wherein they must: formulate a clear problem statement; make reasonable assumptions; apply sound analytical techniques and engineering tools; solve the problem to a certain depth; perform risk analysis on the solution; and deliver a solution on time.

This mindset of an engineering leader was best described by Gene Kranz in his book “Failure is not an Option.” As director of NASA's mission control in the Apollo era, Kranz led his engineers into uncharted territory, the Moon's, and established our unchallenged leadership of space. Cyberspace in the twenty-first century is no less challenging than outer space in the twentieth century. Besides, the security of our Nation relies on establishing and maintaining unchallenged leadership in cyberspace.

### OBJECTS AND SUMMARY OF THE INVENTION

One object of the present invention is to provide a method for developing leaders in cyber security.

A related object of the present invention is to train a cyber security workforce skilled in real-world problem solving.

Another related object of the present invention is to train a cyber security workforce that produces accurate solutions on-time with acceptable risk.

Yet another related object of the present invention is to train a cyber security workforce in the context of both industry and government sector cyber security objectives.

The present invention provides a method for developing leaders in cyber security. Cyber security candidates are selected according to a series of qualifying process steps. Cyber security leader-selectees are then developed into cyber-security leaders through a repetitive, multiple week program of problem solving skill development with emphasis on-time performance; communication skill development through impeccable technical writing and compelling presentations; and by mentoring from experienced cyber security professionals.

Advantages and New Features

There are several advantages and new features of the present invention. An important advantage is the fact that the present invention provides a method for specialized training to ensure the availability of a dedicated cyber security workforce.

Another advantage is that the present invention provides training that demands real-world problem solving as opposed to mere academic exercises.

A further advantage is that the present invention employs selection criteria that select only the best qualified applicants for the specific purpose of cyber security training, as opposed to a generalized program in computer and information technology.

### BRIEF DESCRIPTION OF THE DRAWINGS

FIG. 1 depicts a process flowchart for selecting cyber security trainees from a pool of applicants.

FIG. 2 depicts a process flowchart for developing cyber security trainees into cyber security leaders.

### DETAILED DESCRIPTION OF THE PREFERRED EMBODIMENT

The present invention addresses a significant component of the National Strategy to Secure Cyberspace by providing a method for developing the top cadets in the Reserve Officers Training Corps into the next generation of cyber security leaders. Through a public-private partnership among the Air Force Research Laboratory, the US Military Academy and Syracuse University, the method taught by the present invention transforms cadets into original thinkers, problem solvers and technical leaders.

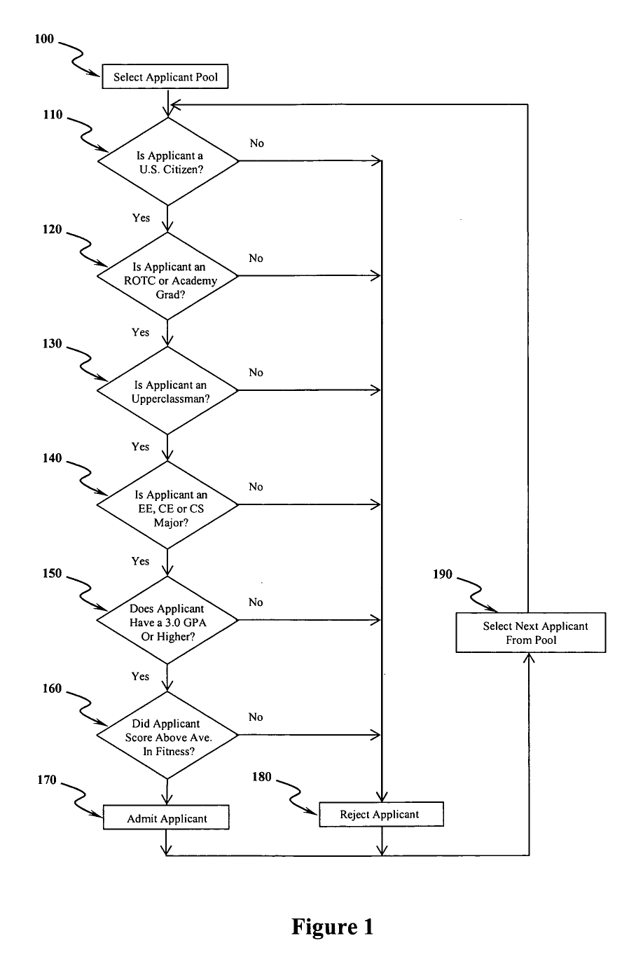

Referring to FIG. 1, the present invention develops cyber security leaders by selecting the top cadets in the Air Force, Army and Navy ROTC, providing them with one-on-one mentoring by nationally recognized cyber security leaders from academia, industry and government, and educating them to solve real-world problems in cyber security. To be selected, the present invention requires that applicants meet certain as follows: applicants must be U.S. citizens 110; applicants must be graduates of a reserve officer training program (ROTC) or a military academy 120; applicants must be upperclassmen 130; applicants must be pursuing a curriculum of study in either electrical engineering, computer engineering or computer science 140; applicants must have good academic standing of at least a 3.0 grade point average measured on a 4.0 scale 150; and applicants must maintain above average physical fitness 160. If all of these criteria are met, the applicant is admitted to the program 170. However, if any one or more of these criteria are not met, the applicant is rejected 180. Additional applicants are selected or rejected in the same manner until a complete class is attained 190.

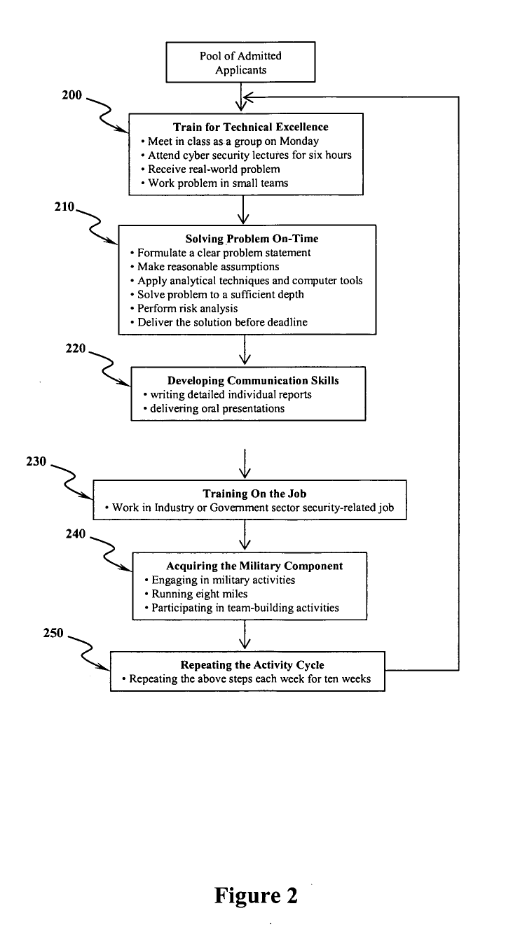

Referring to FIG. 2, the present invention develops cyber security leaders through a 6-pronged approach: by ensuring that students acquire the necessary technical expertise 200; by developing problem solving skills and the ability to deliver on-time performance 210; by communicating through impeccable technical writing and compelling presentations and by mentoring from experienced cyber security professionals 220; by acquiring actual cybersecurity workplace experience 230; by being exposed to a military environment 240; and through repetition of the training routine for a period of several weeks over the duration of the program 250.

The rhetorical question on whether leaders are born or developed can best be answered by looking at a four-minute miler. While genetics play a pivotal role in breaking the four-minute barrier, it takes years of hard training to prepare for the feat. Similarly, by starting with cadets who are committed to serving this Nation and who have demonstrated leadership qualities, and by equipping them with the tools to solve a series of real-world problems of increasing complexity, we will transform them into the next generation of cyber warriors. Therefore, physical conditioning and military type camaraderie 240 aspects of the present invention are required. Group eight mile runs are one typical military activity students must participate in.

Effective communication is arguably a distinguishing trait of a leader. Therefore, the present invention focuses on developing the cadets into effective communicators 220 by requiring individual written reports every week, and several structured team presentations. The instructors and the director who practice the method taught in the present invention will evaluate the reports and the presentations of the cadets.

The present invention requires provides a course meets once a week for a full day. 200 A typical class starts with the timely submission of written reports and the oral presentation of solutions for the previous week's problem. Cadets discuss their solutions with the course Director and the instructor, before moving on to a new problem. Each week brings a different instructor, who assigns a substantial real-world problem 200, then lectures for six hours on the background material for that topic 200.

The instructors are drawn from government, academia and industry. They range from a State Supreme Court Justice teaching on the legal aspects of cyber security, to a college professor formulating encryption algorithms.

The course carries four credit hours of academic credit from a university such as Syracuse University. Successful completion of the all course assignments permits the students to apply the earned credit towards their programs of study at their host institution.

Finally, cadets are assigned to work with mentors at local private or government cyber security laboratories 230. This mentoring relationship exposes the cadets to practical challenges of cyber security, and permits them to establish professional relationships with domain experts.

The duration of the course implemented by the present invention is ten weeks during the June-August timeframe 250. Each week focuses on one area of cyber security as detailed below:
Week 1: Legal Issues: Internet laws and cyber crime, the Fourth Amendment of the US Constitution, search and seizure of data, rights and privacy issues, government versus private workplace, search warrants and wiretap laws, the Patriot's Act.
Week 2: Security Policies: establishing and implementing security policies, confidentiality integrity and availability considerations, identifying vulnerabilities and threats, establishing disaster response and recovery procedures.
Week 3: Cryptography: mathematical basis for data encryption, substitution ciphers and the Data Encryption Standard, private-key and public-key cryptography, key distribution and trusted authority, digital signatures.
Week 4: Computer Security: operating systems and file system security, passwords and one-way hashes, user-space administration, archiving and back-up strategy, intrusion detection, disaster response and recovery.
Week 5: Digital Forensics: procuring and analyzing digital evidence, preserving the chain of custody of digital evidence, recovering hidden data on hard drives, classifying file systems, analyzing slack and sector data, recovering lost clusters.
Week 6: Network Security: TCP-IP packet format and vulnerabilities, protocol and implementation flaws, buffer overflow, denial-of-service attacks, distributed attacks, email, domain name system, web servers.
Week 7: Network Defense: host and network security, firewalls and periphery intrusion detection systems, bastion hosts, network monitors and traffic analyzers, network logfiles, detecting anomalous behavior, network recovery.
Week 8: Network Attack: port scanners and packet sniffers, IP spoofing, identifying vulnerabilities, designing and implementing network attacks, engineering malicious code, worms and viruses, offensive cyber warfare.
Week 9: Steganography: data hiding in images, classifying steganography algorithms and tools, categorizing vessel capacity, detection and recovery of hidden data, digital watermarking, streaming media steganography, multilingual steganography.
Week 10: Next-Generation Cyber Security: wireless local area networks, wireless encryption protocols, Next-Generation Internet Protocols IPv6, embedded systems, 3G cell phones and personal data assistants.

For each topic, the instructor in charge will assign a substantial real-world problem that requires 40 to 80 hours of team work to solve 200. Cadets work on teams of three to solve each problem, then write and submit individual reports 210.

1. A method for developing leaders in cybersecurity comprising the steps of:
selecting trainees from a pool of applicants, said step of selecting further comprising the steps of:
determining whether said applicant is a citizen of one or more preferred nations;
IF it is determined that said applicant is NOT a citizen of said preferred nations, THEN rejecting said applicant and selecting next applicant from said pool of applicants,
OTHERWISE
determining whether said applicant is a graduate of at least one preferred military training program;
IF it is determined that said applicant is NOT a graduate of said at least one preferred military training program, THEN rejecting said applicant and selecting next applicant from said pool of applicants,
OTHERWISE
determining whether said applicant is an upperclassman;
IF it is determined that said applicant is NOT an upperclassman, THEN rejecting said applicant and selecting next applicant from said pool of applicants,
OTHERWISE
determining whether said applicant is a major in at least one preferred curriculum of study;
IF it is determined that said applicant is NOT a major of said at least one preferred curriculum of study, THEN rejecting said applicant and selecting next applicant from said pool of applicants,
OTHERWISE
determining whether said applicant has a minimum required grade point average (GPA) or higher;
IF it is determined that said applicant does NOT have a minimum required grade point average (GPA) or higher, THEN rejecting said applicant and selecting next applicant from said pool of applicants,
OTHERWISE
determining whether said applicant has scored above average in physical fitness;
IF it is determined that said applicant has NOT scored above average in fitness, THEN rejecting said applicant and selecting next applicant from said pool of applicants,
OTHERWISE
admitting said applicant to a pool of admitted applicants.

2. Training said pool of admitted applicants from claim 1, comprising the steps of:
a first step of training said admitted applicants for technical excellence, further comprising the steps of:
meeting in a classroom setting as a group one day per week, wherein further said training for excellence steps comprise
attending cyber security lectures for a plurality of hours;
receiving a real-world problem to be solved;
working toward solution of said problem in small teams;
a second step of training said admitted applicants for timely problem solving, further comprising the steps of:
formulating a clear problem statement;
making reasonable assumptions;
applying analytical techniques and computer tools;
solving said problem to a sufficient depth;
performing risk analysis;
delivering a solution before deadlines;
developing the communications skills of said admitted applicants, further comprising the steps of:
writing detailed individual reports;
delivering oral presentations
a third step of training in the workplace, further comprising the step of:
working on computer and information security tasks in a government or industrial sector workplace;
acquiring a military component, further comprising the steps of:
engaging in military activities;
running for a required distance;
participating in team-building activities; and
repeating said first step of training, said second step of training, said step of developing, said third step of training and said step of acquiring for a plurality of weeks.

3. Method of claim 1, wherein said preferred nation is the United States.

4. Method of claim 1, wherein said at least one preferred military training program is selected from the group consisting of reserve officer training programs (ROTC) and military academies.

5. Method of claim 1, wherein said at least one preferred curriculum of study is selected from the group consisting of electrical engineering, computer engineering and computer science.

6. Method of claim 1, wherein said minimum required grade point average is 3.0 based on a 4.0 scale.

7. Method of claim 2, wherein said plurality of hours is six (6).

8. Method of claim 2, wherein said required distance is eight (8) miles.

9. Method of claim 2, wherein said plurality of weeks is ten (10).
